(19) United States
(12) Patent Application Publication
(10) Pub. No.: US 2024/0270574 A1
(43) Pub. Date: Aug. 15, 2024

(54) FUEL MANUFACTURING SYSTEM

(71) Applicant: HONDA MOTOR CO., LTD., Tokyo (JP)

(72) Inventors: Kota OKAMURA, Saitama (JP); Shiori NAKAJIMA, Saitama (JP)

(21) Appl. No.: 18/430,652

(22) Filed: Feb. 2, 2024

(30) Foreign Application Priority Data
Feb. 7, 2023 (JP) 2023-017119

(51) Int. Cl. C01B 3/32; C10G 2/00; C25B 1/04

(52) U.S. Cl. CPC C01B 3/32; C10G 2/30; C25B 1/04; C01B 2203/062; C01B 2203/1614; C01B 2203/1657

(57) ABSTRACT

A fuel manufacturing system that makes it possible to further improve energy efficiency. the fuel manufacturing system includes: a biomass raw material supply device; a gasification furnace; a liquid fuel manufacturing device; a hydrogen supply device; a heater; and a controller, the controller being able to calculate an amount of heat necessary for gasifying the biomass raw material in the gasification furnace, and control each of an amount of the biomass raw material to be supplied to the heater by the biomass raw material supply device and an amount of the hydrogen to be supplied to the heater by the hydrogen supply device.

This application is based on and claims the benefit of priority from Japanese Patent Application No. 2023-017119, filed on 7 Feb. 2023, the content of which is incorporated herein by reference.

### BACKGROUND OF THE INVENTION

### Field of the Invention

The present invention relates to a fuel manufacturing system. More specifically, the present invention relates to a fuel manufacturing system that manufactures a liquid fuel based on a biomass raw material and renewable energy.

### Related Art

In recent years, electro-synthetic fuels based on, as raw materials, hydrogen generated by using electric power generated by using renewable energy and a carbon source including carbon dioxide and other similar substances discharged from a biomass and factories have been focused on as alternatives to fossil fuels.

A typical procedure of manufacturing a liquid fuel such as methanol or gasoline by using a biomass as a raw material is as described below. That is, through a gasification step of causing a biomass raw material having undergone predetermined preliminary processing to be gasified in a gasification furnace together with water and oxygen to generate a synthesis gas containing hydrogen and carbon monoxide, a cleansing step of cleansing the generated synthesis gas to remove tar, an H₂/CO ratio adjustment step of adjusting an H₂/CO ratio of the synthesis gas having undergone the cleansing step to a target ratio in accordance with a liquid fuel to be manufactured, a desulfurizing step of removing sulfur components from the synthesis gas having undergone the H₂/CO ratio adjustment step, and a fuel manufacturing step of manufacturing a liquid fuel from the synthesis gas having undergone the desulfurizing step, the liquid fuel is manufactured from the biomass raw material.

Note herein that the H₂/CO ratio of the generated synthesis gas having undergone the gasification step does not reach the target ratio in many cases, resulting in a state where hydrogen is insufficient. Therefore, in the H₂/CO ratio adjustment step, carbon monoxide and water are caused to react with each other to generate hydrogen to increase the H₂/CO ratio to the target ratio in many cases. At this time, however, carbon dioxide is generated. According to the technique described in Patent Document 1, it is possible to suppress the amount of carbon dioxide generated in the entire system.
Patent Document 1: Japanese Unexamined Patent Application, Publication No. 2021-147504

### SUMMARY OF THE INVENTION

Incidentally, to gasify a biomass, a predetermined temperature ranging from approximately 700° C. to approximately 900° C. inclusive is required. However, a gasification reaction of a biomass is an endothermic reaction, always requiring additional heat to be supplied. In the technique described in Patent Document 1, a heater is allowed to consume a fuel or electric power, for example, to generate heat to be supplied to a gasification furnace. However, such an issue arises that CO₂ is generated when the fuel or electric power, for example, is consumed. Furthermore, a heat source in a heater, which may be able to further improve energy efficiency, differs depending on operation conditions for a gasification furnace.

In view of the issues described above, an object of the present invention is to provide a fuel manufacturing system that makes it possible to further improve energy efficiency.
(1) The present invention relates to a fuel manufacturing system for manufacturing a liquid fuel from a biomass raw material, the fuel manufacturing system including: a biomass raw material supplier that supplies the biomass raw material; a gasification furnace that gasifies the biomass raw material to generate a synthesis gas containing hydrogen and carbon monoxide; a liquid fuel manufacturer that manufactures the liquid fuel from the synthesis gas generated by the gasification furnace; an electrolizer that uses electric power generated using renewable energy to generate hydrogen from water; a hydrogen supplier that supplies the hydrogen generated by the electrolizer; a heater that heats the gasification furnace; and a controller, the biomass raw material supplier having a first raw material supply path through which the biomass raw material is supplied to the gasification furnace and a second raw material supply path through which the biomass raw material is supplied to the heater, the hydrogen supplier having a first hydrogen supply path through which the hydrogen is supplied to the gasification furnace or the first raw material supply path and a second hydrogen supply path through which the hydrogen is supplied to the heater, the controller being able to calculate an amount of heat necessary for gasifying the biomass raw material in the gasification furnace, and controlling each of an amount of the biomass raw material to be supplied to the heater by the biomass raw material supplier and an amount of the hydrogen to be supplied to the heater by the hydrogen supplier.

According to the invention described in (1), it is possible to provide a fuel manufacturing system that makes it possible to further improve energy efficiency.
(2) The fuel manufacturing system described in (1), in which the controller is configured to calculate a first energy efficiency when the hydrogen supplied from the hydrogen supplier is caused to be combusted in the heater and a second energy efficiency when the biomass raw material supplied from the biomass raw material supplier is caused to be combusted in the heater, and compares the first energy efficiency and the second energy efficiency with each other to select whether to supply the hydrogen from the hydrogen supplier to the heater or to supply the biomass raw material from the biomass raw material supplier to the heater.

According to the invention described in (2), it is possible to heat a gasification furnace to a necessary temperature, with a method that compares combustion of hydrogen gas and combustion of a biomass with each other to further improve energy efficiency.
(3) The fuel manufacturing system described in (2), in which the controller is configured to calculate the first energy efficiency based on hydrogen generation energy for generating hydrogen necessary for heating the gasification furnace and hydrogen generation energy for generating hydrogen necessary for generating water vapor in the heater.

According to the invention described in (3), it is possible to accurately calculate energy efficiency when hydrogen gas is caused to be combusted to heat a gasification furnace.
(4) The fuel manufacturing system described in (1) or (2), in which the controller is configured to calculate an amount of heat necessary for gasifying the biomass raw material in the gasification furnace based on an amount of heat necessary for increasing a temperature in the gasification furnace, an amount of waste heat to be generated when the synthesis gas is to be synthesized, the amount of waste heat to be generated being used to generate water vapor to be supplied to the gasification furnace, and an amount of heat necessary for generating water vapor to be supplied to the gasification furnace.

According to the invention described in (4), it is possible to accurately calculate an amount of heat necessary for gasifying a biomass raw material in a gasification furnace.

### BRIEF DESCRIPTION OF THE DRAWINGS

FIG. 1 is a diagram illustrating a configuration of a fuel manufacturing system according to an embodiment of the present invention;

FIG. 2 is a flowchart illustrating a part of control logic in a controller;

FIG. 3 is a graph illustrating a relationship between an amount of heat necessary for gasification and energy efficiency under predetermined operation conditions;

FIG. 4 is a graph illustrating a relationship between an amount of heat necessary for gasification and energy efficiency under predetermined operation conditions; and

FIG. 5 is a graph illustrating a relationship between an amount of heat necessary for gasification and energy efficiency under predetermined operation conditions.

### DETAILED DESCRIPTION OF THE INVENTION

A fuel manufacturing system according to an embodiment of the present invention will now be described herein with reference to the accompanying drawings.

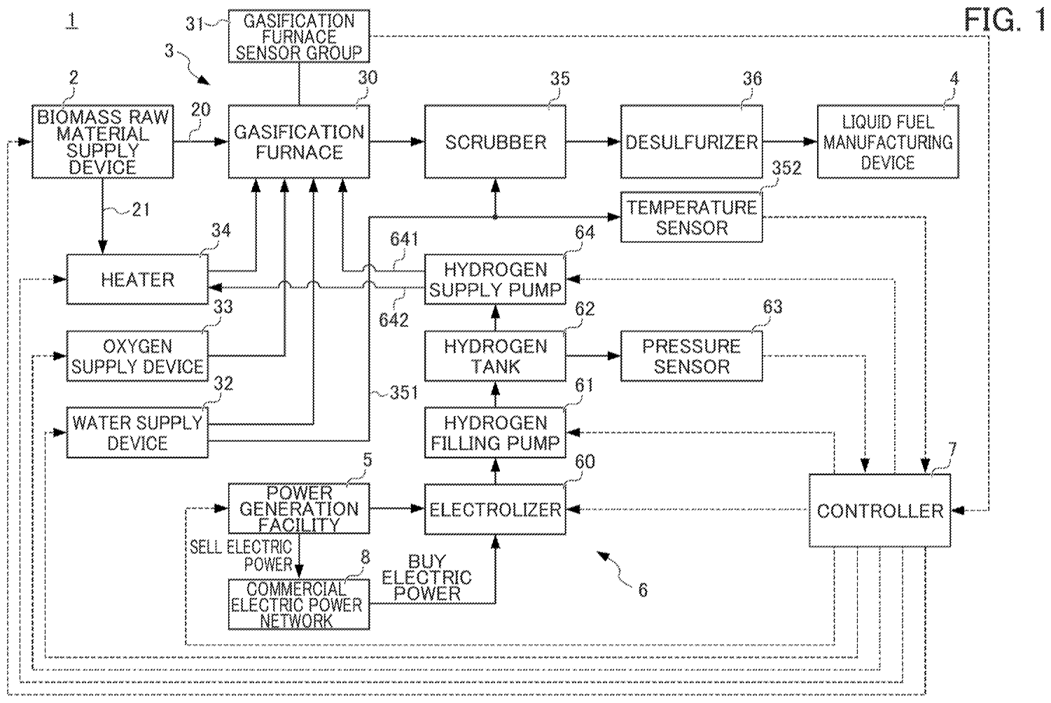

FIG. 1 is a diagram illustrating a configuration of a fuel manufacturing system 1 according to the present embodiment. The fuel manufacturing system 1 includes: a biomass raw material supply device 2 that supplies a biomass raw material; a gasifier 3 that causes the biomass raw material supplied from the biomass raw material supply device 2 to be gasified to generate a synthesis gas containing hydrogen and carbon monoxide; a liquid fuel manufacturing device 4 that manufactures a liquid fuel from the synthesis gas supplied from the gasifier 3; a power generation facility 5 that uses renewable energy to generate electric power; a hydrogen generation and supply device 6 that uses the electric power generated in the power generation facility 5 to generate hydrogen from water to supply the generated hydrogen to the gasifier 3; and a controller 7 that controls the gasifier 3, the power generation facility 5, and the hydrogen generation and supply device 6, by which the liquid fuel is manufactured from the biomass raw material.

The biomass raw material supply device 2 causes a biomass raw material including rice hulls, bagasse, and wooden materials, for example, to undergo predetermined preliminary processing, and supplies the biomass raw material having undergone the preliminary processing to a gasification furnace 30 in the gasifier 3 via a first raw material supply path 20. Note herein that the preliminary processing for a biomass raw material includes, for example, a drying step of drying the raw material and a crushing and grinding step of crushing and grinding the raw material, for example.

The biomass raw material supply device 2 supplies the biomass raw material to a heater 34 in the gasifier 3 via a second raw material supply path 21. An amount of the biomass raw material to be supplied from the biomass raw material supply device 2 to the heater 34 is controlled by the controller 7.

The gasifier 3 includes: the gasification furnace 30 that causes the biomass raw material supplied via the first raw material supply path 20 to be gasified; a gasification furnace sensor group 31 including a plurality of sensors that detect a state inside the gasification furnace 30; a water supply device 32 that supplies water to the gasification furnace 30; an oxygen supply device 33 that supplies oxygen to the gasification furnace 30; the heater 34 that heats the gasification furnace 30; a scrubber 35 that cleanses a synthesis gas discharged from the gasification furnace 30; and a desulfurizer 36 that removes sulfur components from the synthesis gas cleansed by the scrubber 35 and supplies the synthesis gas to the liquid fuel manufacturing device 4.

The water supply device 32 supplies water stored in a non-illustrated water tank to the gasification furnace 30. The oxygen supply device 33 supplies oxygen stored in a non-illustrated oxygen tank to the gasification furnace 30. The heater 34 heats the gasification furnace 30. An amount of water to be supplied from the water supply device 32 to the gasification furnace 30, an amount of oxygen to be supplied from the oxygen supply device 33 to the gasification furnace 30, and an amount of heat to be loaded from the heater 34 to the gasification furnace 30 are controlled by the controller 7. In the fuel manufacturing system 1 according to the present embodiment, supplying hydrogen from the hydrogen generation and supply device 6 described later to the gasification furnace 30 or the first raw material supply path 20 may make actively supplying water from the water supply device 32 to the gasification furnace 30 unnecessary. In this case, it is also possible to make the water supply device 32 unnecessary in the fuel manufacturing system 1.

The water supply device 32 may include a water vapor generator that vaporizes water to supply water vapor to the gasification furnace 30. Furthermore, it is desirable that the water supply device 32 utilizes waste heat generated when a fuel is synthesized to vaporize water in the water vapor generator or to heat water to be vaporized. A heat exchanging flow path 351 is a flow path circulating between the water supply device 32 and the scrubber 35, for example. The flow path is filled with a heat medium (for example, water). A non-illustrated pump causes the heat medium to circulate between the water supply device 32 and the scrubber 35. Temperatures of the heat medium in the heat exchanging flow path 351 before and after waste heat is received are detected by a temperature sensor 352. A detection signal of the temperature sensor 352 is sent to the controller 7. Note that, although, in FIG. 1, the water supply device 32 is able to utilize waste heat generated in the scrubber 35 via the heat exchanging flow path 351, the case described above is a mere example, and the present invention is not limited to the case. The water supply device 32 may be able to utilize waste heat generated in the gasification furnace 30, the desulfurizer 36, the liquid fuel manufacturing device 4, and the flow path coupling those components.

The heater 34 consumes the biomass raw material supplied via the second raw material supply path 21 and hydrogen supplied via a second hydrogen supply path 642 to heat the gasification furnace 30. Furthermore, as the hydrogen is supplied to the heater 34, and the hydrogen is caused to be combusted, the gasification furnace 30 is heated, and water vapor is supplied. Whether the heater 34 consumes either the biomass raw material or the hydrogen described above to generate heat is determined and controlled by the controller 7.

When amounts of water, oxygen, and heat, for example, are loaded by the water supply device 32, the oxygen supply device 33, and the heater 34, respectively, as described above, into the gasification furnace 30 loaded with the biomass raw material, a total of ten types of gasification reactions as described in Equations (1-1) to (1-5) below, for example, and their reverse reactions proceed in the gasification furnace 30, and a synthesis gas containing hydrogen and carbon monoxide is generated.

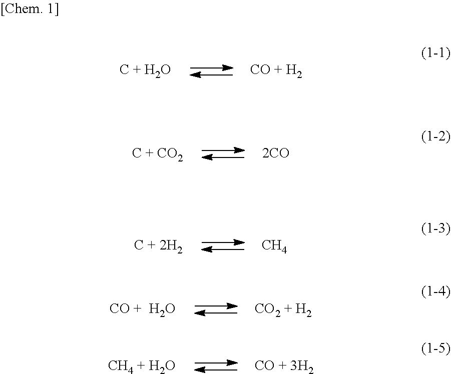

The gasification furnace sensor group 31 includes, for example, a pressure sensor that detects pressure in the gasification furnace 30, a temperature sensor that detects a temperature in the gasification furnace 30, an H₂/CO sensor that detects an H₂/CO ratio corresponding to a ratio between hydrogen and carbon monoxide in the synthesis gas in the gasification furnace 30, and a CO₂ sensor that detects carbon dioxide in the gasification furnace 30. Detection signals of the sensors forming the gasification furnace sensor group 31 are sent to the controller 7.

The gasifier 3 allows a synthesis gas generated through the gasification reactions as described in Equations (1-1) to (1-5) above and their reverse reactions and the hydrogen supplied from the hydrogen generation and supply device 6 described later to be mixed with each other, adjusts the H₂/CO ratio in the synthesis gas to a predetermined target ratio in accordance with a liquid fuel to be manufactured (for example, when methanol is to be manufactured, a target ratio of the H₂/CO ratio is 2), and supplies the synthesis gas to the liquid fuel manufacturing device 4.

The liquid fuel manufacturing device 4 includes and uses a methanol synthesizing machine, a methanol-to-gasoline (MTG) synthesizing machine, a Fischer Tropsch (FT) synthesizing machine, and an upgrading machine, for example, to manufacture a liquid fuel such as methanol or gasoline from the synthesis gas having undergone adjustment to the predetermined H₂/CO ratio in the gasifier 3.

The power generation facility 5 includes a wind power generation facility that uses a wind force representing renewable energy to generate electric power and a photovoltaic power generation facility that uses sunlight representing renewable energy to generate electric power, for example. The power generation facility 5 is coupled to the hydrogen generation and supply device 6, making it possible to supply electric power generated using the renewable energy in the wind power generation facility and the photovoltaic power generation facility, for example, to the hydrogen generation and supply device 6. The power generation facility 5 is also coupled to a commercial electric power network 8. Therefore, it is possible to supply, to the commercial electric power network 8, and sell, to an electric power company, some or all of the electric power generated in the power generation facility 5.

The hydrogen generation and supply device 6 includes an electrolizer 60, a hydrogen filling pump 61, a hydrogen tank 62, a pressure sensor 63, and a hydrogen supply pump 64 serving as a hydrogen supply device. By using the configuration described above, the hydrogen generation and supply device 6 uses the electric power supplied from the power generation facility 5, generates hydrogen, and supplies the generated hydrogen to the gasifier 3.

The electrolizer 60 is coupled to the power generation facility 5 to use electric power supplied from the power generation facility 5 and to generate hydrogen from water through electrolysis. The electrolizer 60 is also coupled to the commercial electric power network 8. Therefore, the electrolizer 60 is able to use not only electric power supplied from the power generation facility 5, but also electric power bought from an electric power company and supplied from the commercial electric power network 8, to generate hydrogen. An amount of hydrogen to be generated by the electrolizer 60 is controlled by the controller 7.

The hydrogen filling pump 61 compresses the hydrogen generated by the electrolizer 60 to fill the hydrogen tank 62 with the generated and compressed hydrogen. An amount of the hydrogen filled by the hydrogen filling pump 61 is controlled by the controller 7. The hydrogen tank 62 stores the hydrogen compressed by the hydrogen filling pump 61. The pressure sensor 63 detects in-tank pressure in the hydrogen tank 62 and sends a detection signal to the controller 7. An amount of the hydrogen remaining in the hydrogen tank 62 is calculated by the controller 7 based on the detection signal of the pressure sensor 63. Therefore, the pressure sensor 63 and the controller 7, in the present embodiment, form remaining-hydrogen-amount acquisition means that acquires an amount of the hydrogen remaining in the hydrogen tank 62.

The hydrogen supply pump 64 supplies the hydrogen stored in the hydrogen tank 62 to the gasification furnace 30 in the gasifier 3 via a first hydrogen supply path 641. An amount of the hydrogen to be supplied from the hydrogen supply pump 64 to the gasification furnace 30 is controlled by the controller 7. Note that, although, in FIG. 1, it has been described the case where the hydrogen stored in the hydrogen tank 62 is supplied by the hydrogen supply pump 64 to the gasification furnace 30, the present invention is not limited to the case. The hydrogen stored in the hydrogen tank 62 may be supplied to a side that lies upstream of the gasification furnace 30, more specifically, to the first raw material supply path 20 for the biomass raw material.

The hydrogen supply pump 64 supplies the hydrogen stored in the hydrogen tank 62 to the heater 34 in the gasifier 3 via the second hydrogen supply path 642. An amount of the hydrogen to be supplied from the hydrogen supply pump 64 to the heater 34 is controlled by the controller 7. By causing hydrogen to be combusted in the heater 34, water vapor is simultaneously generated, making it possible, in this case, to supply the water vapor, together with heat generated in the heater 34, to the gasification furnace 30.

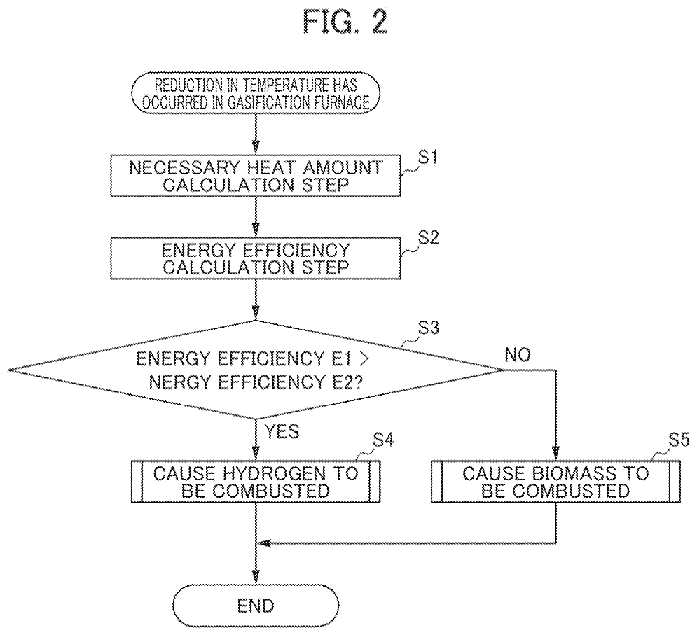

The controller 7 is a computer that controls, based on detection signals from the gasification furnace sensor group 31 and detection signals from the pressure sensor 63 in the hydrogen tank 62 and the temperature sensor 352, for example, an amount of the biomass raw material to be supplied from the biomass raw material supply device 2 to the heater 34, an amount of water to be supplied by the water supply device 32, an amount of oxygen to be supplied by the oxygen supply device 33, an amount of heat loaded by the heater 34, an amount of hydrogen to be generated by the electrolizer 60, an amount of hydrogen to be filled by the hydrogen filling pump 61, an amount of hydrogen to be supplied from the hydrogen supply pump 64 to the gasification furnace 30, and an amount of hydrogen to be supplied from the hydrogen supply pump 64 to the heater 34, for example. A specific procedure of controlling an amount of hydrogen to be supplied by the controller 7, for example, will be described later with reference to FIGS. 2 to 5.

Next, with reference to FIG. 2, a procedure of causing the controller 7 to determine whether to supply the biomass raw material from the biomass raw material supply device 2 to the heater 34 or to supply hydrogen from the hydrogen supply pump 64 to the heater 34 will now be described herein.

The controller 7 executes, when a temperature in the gasification furnace 30 has lowered below a predetermined threshold value, a necessary heat amount calculation step S1, an energy efficiency calculation step S2, an energy efficiency comparison step S3, and a hydrogen combustion step S4 or a biomass combustion step S5, in this order, as illustrated in FIG. 2.

The necessary heat amount calculation step S1 is a step of calculating an amount of heat Q_{need} [W] necessary for gasifying the biomass raw material. The amount of heat Q_{need} [W] is calculated with Equation (2) described below.

$${Q}_{need} = {Q}_{Heat} + {Q}_{Vapor} - {Q}_{Waste} \qquad ( 2 )$$

The amount of heat Q_{Heat} [W] in Equation (2) described above indicates an amount of heat necessary for increasing a temperature T₂ [° C.] in the gasification furnace 30 to a predetermined threshold value T₁ [° C.]. The amount of heat Q_{Heat} [W] is calculated with Equation (2-1) described below. In Equation (2-1) described below, C indicates a heat capacity [J/K] in the gasification furnace 30.

$${Q}_{Heat} = C ( {T}_{1} - {T}_{2} ) \qquad ( 2 ‐ 1 )$$

The amount of heat Q_{Waste} [W] in Equation (2) described above indicates an amount of waste heat to be generated in a fuel synthesizing step, which is used to generate water vapor supplied to the gasification furnace 30. The amount of heat Q_{Waste} is calculated with Equation (2-2) described below. In Equation (2-2) described below, ci indicates a specific heat [J/(g·° C.)] of a heat medium that transfers waste heat. Similarly, m₁ indicates a predetermined flow rate [g/s] of the heat medium. Similarly, T₃ indicates a temperature [° C.] of the heat medium before waste heat is received. Similarly, T₄ indicates a temperature [° C.] of the heat medium after waste heat is received. A sensor (for example, the temperature sensor 352) constantly measures and acquires T₃ and T₄ described above.

$${Q}_{Waste} = {c}_{1} \times {m}_{1} \times ( {T}_{3} - {T}_{4} ) \qquad ( 2 ‐ 2 )$$

In Equation (2) described above, the amount of heat Q_{Vapor} [W] indicates an amount of heat necessary for generating water vapor supplied to the gasification furnace 30. The amount of heat Q_{Vapor} is calculated with Equation (2-3) described below. In Equation (2-3) described below, C₂ indicates a specific heat (approximately 4.2 [J/(g·° C.)]) of water in a liquid state. Similarly, C₃ indicates a specific heat of water in a gas state (water vapor). Similarly, T₅ indicates a temperature [° C.] of water used for generating water vapor. Similarly, T₆ indicates a predetermined target temperature [° C.] of water vapor.

$${Q}_{Vapor} = {m}_{2} [ {c}_{2} ( 100 - {T}_{5} ) + 2780 [ J / g ] ( heat of vaporization of water ) + {c}_{3} ( {T}_{6} - 100 ) ] \qquad ( 2 ‐ 3 )$$

In Equation (2-3) described above, m₂ indicates an amount of water vapor [g/s] necessary for gasification. Equation (2-4) described below is used to calculate m₂. In Equation (2-4) described below, L indicates a supply amount [g/s] of the biomass raw material supplied to the gasification furnace 30 per unit time. Similarly, C content indicates a carbon content in the biomass raw material supplied to the gasification furnace 30. An analysis value that differs depending on a type of a biomass raw material represents C content. A ratio between an amount of water vapor and a carbon amount represents an S/C, which is set beforehand.

$${m}_{2} = L \times C content \times 1 / 12 \times S / C \times 18 \qquad ( 2 ‐ 4 )$$

The energy efficiency calculation step S2 is a step of respectively calculating two types of energy efficiency, that is, a first energy efficiency E1 when the amount of heat Q_{need} calculated in the necessary heat amount calculation step S1 is provided through combustion of hydrogen and a second energy efficiency E2 when the amount of heat Q_{need} is provided through combustion of the biomass raw material.

The first energy efficiency E1 and the second energy efficiency E2 are calculated with Equation (3) described below. Note that, for synthesis gas energy in Equation (3) described below, an amount of heat of a fuel manufactured in the fuel manufacturing system 1 is used as an actual value.

$$Energy efficiency = Synthesis gas energy / Loaded energy \qquad ( 3 )$$

When the first energy efficiency E1 is calculated, loaded energy in Equation (3) is calculated with Equation (3-1) described below. Biomass loaded energy and Hydrogen generation energy in Equation (3-1) described below are constant values determined based on capability of a device and other factors. Similarly, necessary hydrogen amount is an amount of hydrogen supplied to the gasification furnace 30 in the gasifier 3, and uses an actual value.

$$Loaded energy = Biomass loaded energy + ( Hydrogen generation energy \times Necessary hydrogen amount ) + {E}_{Heat} + {E}_{Vapor} \qquad ( 3 ‐ 1 )$$

In Equation (3-1) described above, E_{Heat} is hydrogen generation energy necessary for heating the gasification furnace 30, and is calculated with Equation (3-2) described below. In Equation (3-2) described below, Q_{Heat} is calculated with Equation (2-1) described above. In Equations (3-2) and (3-3) described below, electrolytic efficiency is electric energy necessary when a necessary hydrogen amount is generated through electrolysis of water, and is a numeric value determined based on capability of an electrolizer.

$${E}_{Heat} = ( {Q}_{Heat} \times 2 \times Electrolytic efficiency [ kJ / g ] ) / Hydrogen combustion energy [ kJ / mol ] \qquad ( 3 ‐ 2 )$$

In Equation (3-1) described above, E_{Vapor} is hydrogen generation energy necessary for generating water vapor supplied to the gasification furnace 30, and is calculated with Equation (3-3) described below.

$${E}_{Vapor} = ( {m}_{2} \times 2 \times Electrolytic efficiency [ kJ / g ] ) / 18 \qquad ( 3 ‐ 3 )$$

When the second energy efficiency E2 is calculated, loaded energy in Equation (3) is calculated with Equation (3-4) described below. In Equation (3-4) described below, biomass loaded energy, hydrogen generation energy, and necessary hydrogen amount are defined similarly or identically to those in Equation (3-1).

$$Loaded energy = Biomass loaded energy + ( Hydrogen generation energy \times Necessary hydrogen amount ) \qquad ( 3 ‐ 4 )$$

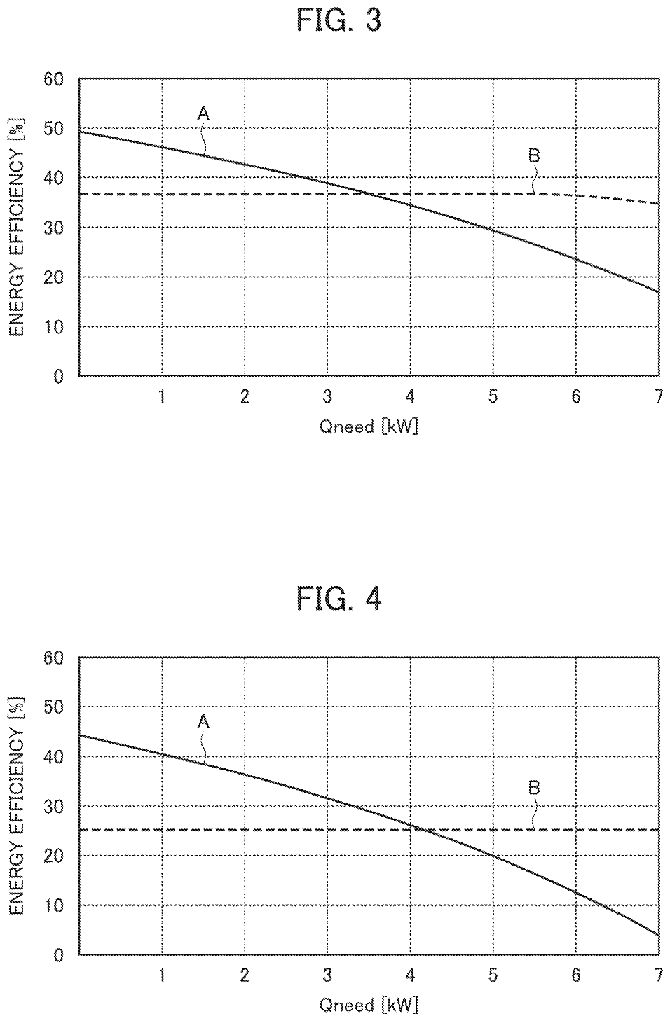

The energy efficiency comparison step S3 is a step of comparing the first energy efficiency E1 and the second energy efficiency E2 with each other, which are calculated in the energy efficiency calculation step S2. Since, as described above, as hydrogen is caused to be combusted in the heater 34, water vapor is simultaneously generated, there may be a case where acquiring an amount of heat necessary for gasification by causing hydrogen to be combusted in the heater 34 leads to higher efficiency in the fuel manufacturing system 1 as a whole, depending on a situation. On the other hand, there may be a case where acquiring an amount of heat necessary for gasification by causing a biomass to be combusted in the heater 34 leads to higher efficiency in the fuel manufacturing system 1 as a whole. These cases will now be described herein with reference to FIGS. 3 to 5.

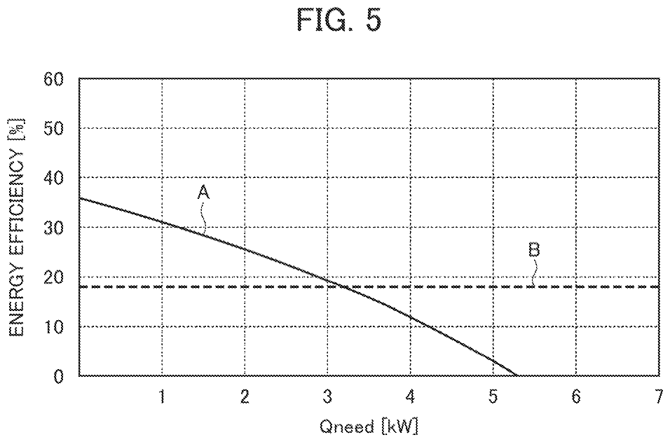

FIGS. 3 to 5 are graphs illustrating, respectively, relationships between the first energy efficiency E1 and the second energy efficiency E2 and the amount of heat Q_{need} [kW] in the fuel manufacturing system 1 under different operation conditions. In FIGS. 3 to 5, curves A correspond to the second energy efficiency E2, and curves B correspond to the first energy efficiency E1. In FIGS. 3 to 5, a biomass supply amount is 3 kg/h, and an S/C is 3. FIG. 3 illustrates an example when provided waste heat generated when a fuel is synthesized occupies 80% of energy of generating water vapor supplied to the gasification furnace 30. Similarly, FIGS. 4 and 5 illustrate, respectively, examples when provided waste heat generated when a fuel is synthesized occupies 50% and 10%. According to FIGS. 3 to 5, it is obvious that the operation conditions and the amount of heat Q_{need} [kW] in the fuel manufacturing system 1 cause the first energy efficiency E1 and the second energy efficiency E2 to change.

In the energy efficiency comparison step S3, the first energy efficiency E1 and the second energy efficiency E2 are compared with each other under such predetermined conditions as illustrated in FIGS. 3 to 5. When the first energy efficiency E1 is greater than the second energy efficiency E2, the processing proceeds to the hydrogen combustion step S4. When the first energy efficiency E1 is smaller than the second energy efficiency E2, the processing proceeds to the biomass combustion step S5.

In the hydrogen combustion step S4, the controller 7 controls the hydrogen supply pump 64 to supply the hydrogen stored in the hydrogen tank 62 to the heater 34 in the gasifier 3 via the second hydrogen supply path 642.

In the biomass combustion step S5, the controller 7 controls the biomass raw material supply device 2 to supply the biomass raw material to the heater 34 in the gasifier 3 via the second raw material supply path 21.

With the fuel manufacturing system 1 according to the present embodiment described above, it is possible to further improve the energy efficiency of the system as a whole.

Although the embodiment of the present invention has been described, the present invention is not limited to the embodiment. The present invention may be appropriately altered in detailed configuration within the scope of the present invention.

### EXPLANATION OF REFERENCE NUMERALS

1 Fuel manufacturing system
2 Biomass raw material supply device
20 First raw material supply path
21 Second raw material supply path
30 Gasification furnace
4 Liquid fuel manufacturing device
60 Electrolizer
64 Hydrogen supply pump (hydrogen supply device)
641 First hydrogen supply path
642 Second hydrogen supply path
7 Controller

What is claimed is:

1. A fuel manufacturing system for manufacturing a liquid fuel from a biomass raw material, the fuel manufacturing system comprising:
a biomass raw material supplier that supplies the biomass raw material;
a gasification furnace that gasifies the biomass raw material to generate a synthesis gas containing hydrogen and carbon monoxide;
a liquid fuel manufacturer that manufactures the liquid fuel from the synthesis gas generated by the gasification furnace;
an electrolizer that uses electric power generated using renewable energy to generate hydrogen from water;
a hydrogen supplier that supplies the hydrogen generated by the electrolizer;
a heater that heats the gasification furnace; and
a controller,
the biomass raw material supplier having a first raw material supply path through which the biomass raw material is supplied to the gasification furnace and a second raw material supply path through which the biomass raw material is supplied to the heater,
the hydrogen supplier having a first hydrogen supply path through which the hydrogen is supplied to the gasification furnace or the first raw material supply path and a second hydrogen supply path through which the hydrogen is supplied to the heater,
the controller being able to calculate an amount of heat necessary for gasifying the biomass raw material in the gasification furnace, and control each of an amount of the biomass raw material to be supplied to the heater by the biomass raw material supplier and an amount of the hydrogen to be supplied to the heater by the hydrogen supplier.

2. The fuel manufacturing system according to claim 1, wherein the controller is configured to
calculate a first energy efficiency when the hydrogen supplied from the hydrogen supplier is caused to be combusted in the heater and a second energy efficiency when the biomass raw material supplied from the biomass raw material supplier is caused to be combusted in the heater, and
compare the first energy efficiency and the second energy efficiency with each other to select whether to supply the hydrogen from the hydrogen supplier to the heater or to supply the biomass raw material from the biomass raw material supplier to the heater.

3. The fuel manufacturing system according to claim 2, wherein the controller is configured calculate the first energy efficiency based on hydrogen generation energy for generating hydrogen necessary for heating the gasification furnace and hydrogen generation energy for generating hydrogen necessary for generating water vapor in the heater.

4. The fuel manufacturing system according to claim 1, wherein the controller is configured to calculate an amount of heat necessary for gasifying the biomass raw material in the gasification furnace based on an amount of heat necessary for increasing a temperature in the gasification furnace, an amount of waste heat to be generated when the synthesis gas is to be synthesized, the amount of waste heat to be generated being used to generate water vapor to be supplied to the gasification furnace, and an amount of heat necessary for generating water vapor to be supplied to the gasification furnace.
